(19) United States
(12) Patent Application Publication
(10) Pub. No.: US 2006/0061024 A1
(43) Pub. Date: Mar. 23, 2006

(54) Coil spring and reciprocating compressor having the same

(76) Inventors: Won-Hyun Jung, Gyeongsangnam-Do (KR); Seong-Yeol Hyun, Gyeongsangnam-Do (KR); Gi-Bong Kwon, Gyeongsangnam-Do (KR); Su-Won Lee, Gyeongsangnam-Do (KR)

Correspondence Address: BIRCH STEWART KOLASCH & BIRCH, PO BOX 747, FALLS CHURCH, VA, 22040-0747, US

(21) Appl. No.: 10/547,937

(22) PCT Filed: Mar. 11, 2004
(86) PCT No.: PCT/KR04/00509

§ 371 Date: Sep. 8, 2005

(30) Foreign Application Priority Data
Mar. 11, 2003 (KR) 10-2003-0015234

(51) Int. Cl. F16F 1/06

(52) U.S. Cl. 267/167

(57) ABSTRACT

A coil spring in accordance with the present invention includes inner coils formed as a wire is wound plural times; and an inflection portion having a nonlinear shape and formed at an outer circumferential surface of the end coil, which is positioned toward the inner coil. When connected to other component and is constricted and relaxed to absorb an impact or a vibration transmitted from the outside, the coil spring minimizes friction generated between itself and other components so that reliability of a reciprocating compressor having the coil spring can be improved.

### TECHNICAL FIELD

The present invention relates to a spring and a compressor having the same, and particularly, to a coil spring and a reciprocating compressor having the same capable of minimizing abrasion and noise generated when a load or an impact is repeatedly applied to the spring connected to other components.

### BACKGROUND ART

A spring absorbs an external force and accumulates the external force as an elastic energy by its elasticity. Accordingly, when an impact is applied to a spring from the outside, the spring absorbs and thus relieves the impact. In addition, when a constantly repeated force, that is, a vibration is transmitted to the spring from the outside, the spring absorbs the vibration and prevents the vibration from being transmitted to other components.

There are various kinds of spring such as a coil spring, a plate spring, a torsion bar or the like according to a shape and a function, and its usable range is very wide.

Among the springs, a coil spring has high reliability in operation, is easy to produce, and is low-priced, especially when a mole only for the coil spring is used. For those reasons, the coil spring is being widely used for various apparatuses.

The coil spring is formed as a wire rod circularly wound is straightened, passing through a straightening device, and the straightened wire is bent at a preset bending angle by a forming tool with the preset number of turns.

FIG. 1 is a front view showing one embodiment of a general coil spring, and FIG. 2 is a plane view of the coil spring. As shown therein, the coil spring is formed in such a manner that a wire is spirally wound several times at regular intervals, having the same diameters. That is, the coil spring consists of inner coils wound plural times and end coils 20 respectively positioned at both ends of the inner coils 10.

The inner coils are formed as a wire is spirally wound several times at regular intervals, having the same outer diameters, and a diameter of a wire corresponding to the inner coils is the same.

An outer surface of the end coil 20 forms a support surface 21 which comes in contact with other components, the support surface 21 is formed in a plane perpendicular to an axis of the coil spring, and an end 22 of the end coil is almost in contact with the very adjacent coil 11 of the inner coils 10. That is, a surface of the end coil 20, which faces the inner coils 10, is formed curved, and its other surface is a support surface 21, a plane. An interval (α1) between the curved surface and the coil 11 adjacent to the curved surface gets wider from the end 22 of the end coil.

Operations of such a coil spring will now be described.

First, the coil spring is positioned between two components, and, at this time, support surfaces of the end coils are contactedly supported by these components, respectively.

When a certain force is applied to the coil spring from a component by which the coil spring is supported, the force is transmitted to the coil spring, thus, as shown in FIG. 3, the end coil 20 and the inner coils 10 constituting the coil spring are deformed by the force transmitted to the coil spring, and therefore intervals between the coils are narrowed. The end coil 20 and the inner coils 10 constituting the coil spring absorb the force applied to the coil spring with being deformed.

In such processes, since the end coil 20 and the inner coil 10 are wound at a prescribed pitch angle, a torsion moment and a bending moment work on the coils by a force applied in an axial direction of the coil spring, whereby the coils are deformed. At this time, a rotation moment works on the coils by a repulsive force due to the torsion moment and the bending moment working on the coil, thereby moving the end coil 20 of the coil spring in a circumference direction. Friction is generated between the support surface 21 of the end coil and the component due to a relative motion between the support surface 21 of the end coil 20 and the component, and abrasion is generated at the coil spring and the component by the friction, thereby shortening a life span of the component and causing damage of the component. In addition, friction noise is generated due to the friction between the coil spring and the component.

### DISCLOSURE

Therefore, it is an object of the present invention to provide a coil spring and a reciprocating compressor having the same capable of minimizing friction and friction noise generated between the coil spring and other components when the coil spring is connected with other component and is constricted and relaxed to absorb an impact and a vibration transmitted from the outside.

To achieve the above object, there is provided a coil spring including inner coils formed as a wire is wound plural times; end coils respectively formed at both ends of the inner coils; and an inflection portion having a nonlinear shape and formed at an outer circumferential surface of the end coil, which faces the inner coil.

To achieve the above object, there is also provided a reciprocating compressor with a spring including a casing; frames positioned in the casing; a driving motor fixedly coupled to the frames and for generating a linearly reciprocating driving force; a cylinder fixed to the frames; a piston receiving a driving force of the driving motor and linearly reciprocating in the cylinder; a suction valve for controlling gas introduced into the cylinder; a discharge valve assembly through which gas compressed in the cylinder is discharged; and coil springs elastically supporting the piston and causing a resonant movement of the piston, wherein the coil spring includes inner coils formed as a wire is wound plural times; end coils positioned at both ends of the inner coils and an inflection portion having a nonlinear shape and formed at an outer circumferential surface of the end coil, which is positioned toward the inner coils.

### DESCRIPTION OF DRAWINGS

FIGS. 1, 2 are front and plane views showing one embodiment of a general coil spring respectively;

FIG. 3, is a front view showing an operational state of the coil spring;

FIGS. 4, 5 are front and plane views showing one embodiment of a coil spring in accordance with the present invention;

FIG. 6 is a front view partially showing a different embodiment of a coil spring in accordance with the present invention;

FIG. 7 is a front view showing an operational state of a coil spring in accordance with the present invention;

FIG. 8 is a sectional view showing one embodiment of a reciprocating compressor having a coil spring in accordance with the present invention;

FIG. 9 is a front view showing partially enlarged reciprocating compressor in accordance with the present invention; and

FIG. 10 is a front view showing operational states of coils spring constituting a reciprocating compressor in accordance with the present invention.

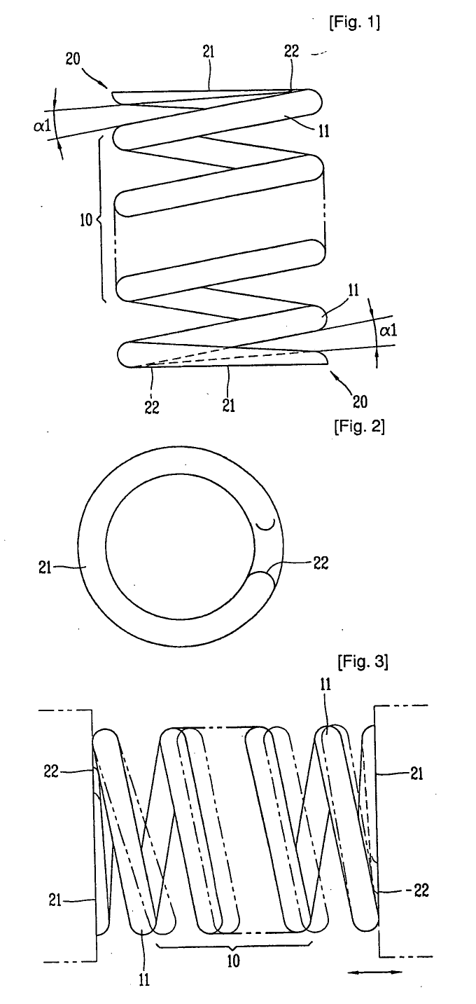

### MODE FOR INVENTION

Reference will now be made in detail to the preferred embodiments of the present invention, examples of which are illustrated in the accompanying drawings.

First, one embodiment of a coil spring in accordance with the present invention will now be described.

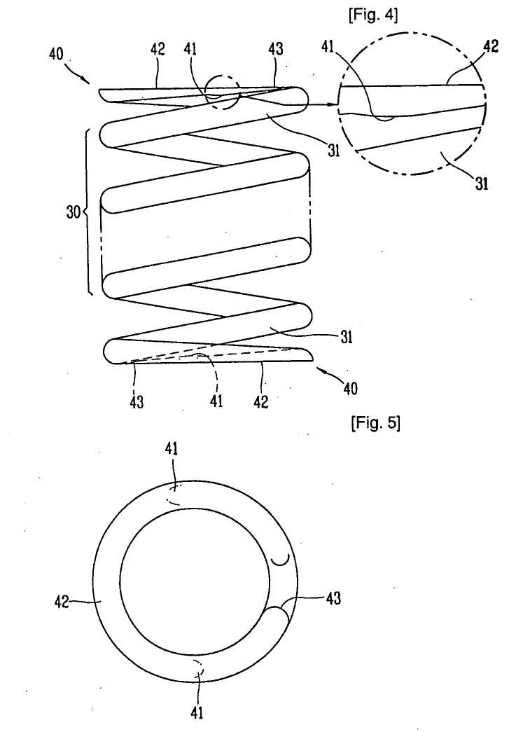

FIG. 4 is a front view showing one embodiment of a coil spring in accordance with the present invention, and FIG. 5 is a plane view showing the coil spring.

As shown therein, the coil spring includes: inner coils 30 formed as a wire is wound plural times; end coils 40 respectively positioned at both ends of the inner coils 30; and an inflection portion 41 having a nonlinear shape and formed at an outer circumferential surface of the end coil 40 which positioned toward the inner coils 30.

The wire is made of a material having stiffness, and the inner coils 30 and the end coil 40 are formed as one wire is spirally wound plural times. A diameter of a wire forming the inner coils 30 is the same, and pitch angles of the inner coils are the same. Accordingly, intervals between the inner coils 30 are regular, and their outer diameters are the same.

Outer surfaces of end coils respectively positioned at both ends of the inner coils 30 are support surfaces 42 which comes in contact with other components, and the support surface 42 is a plane perpendicular to an axis of the end coil 40, and an end 43 of the end coil 40 is almost in contact with the very adjacent inner coil 31. That is, a surface of the end coil 40, which faces the inner coils 30, is formed curved, and its other surface of the end coil 40 is a plane. An interval between the curved surface and the adjacent inner coil 31 gets wider from the end 43 of the end coil 40.

The inflection portions 41 are respectively formed at the curved surfaces of the two end coils 40 respectively positioned at both sides of the inner coils 30. A thickness of the end coil 40 gets thicker from its end. At a portion distanced from the end at a certain distance the thickness becomes the same or is decreased. The portion where its thickness becomes the same or is decreased refers to an inflection portion 41. And, the thickness gets thicker from the inflection portion 41.

The inflection portion 41 is positioned at a certain distance from the end 43 of the end coil 40, and the distances from each end 43 of the end coils 40 to each inflection portion 41 are the same.

Intervals between the inner coils 30 may not be regular, and also, each diameter of the inner coils 30 may not be the same.

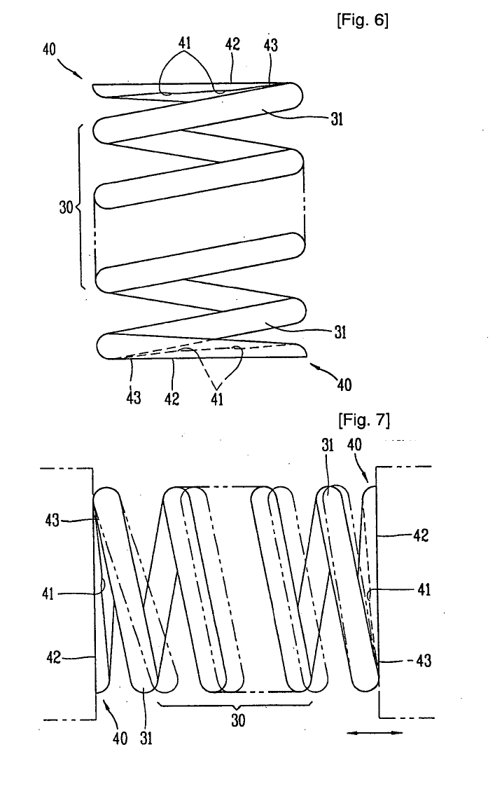

As still another embodiment of the present invention, as shown in FIG. 6, a plurality of inflection portions 41 is formed at the end coil 40. The inflection portions 41 are respectively formed at certain distances from an end of the end coil 40, and an inflection portion 41 positioned toward an end of the end coil 40 is the lowest in height.

Hereinafter, operations of a coil spring in accordance with the present invention will now be described.

First, as shown in FIG. 7, a coil spring in accordance with the present invention is installed between two components. At this time, support surfaces 42 of the end coils 40 are contactedly supported to the components, respectively. In this state, when a force such as an impact, a vibration or the like is applied to the coil spring, the coil spring is constricted and relaxed to absorb the force such as the impact, the vibration or the like.

To explain such processes in more detail, when a force is applied in a longitudinal direction of the coil spring, a bending moment and a torsion moment work on inner coils 30 and end coils 40 constituting the coil spring thereby narrowing intervals between the inner coils 30 and an interval between the inner coil 31 and the end coil 40. Due to such an elastic deformation, the coil spring absorbs the force. At this time, a repulsive force to a force applied to the coil spring is applied to other components through support surfaces 42 of the coil spring, and a rotation moment is applied thereto because of the repulsive force.

But, in a process that intervals between coils are narrowed by the force applied to the coil spring, the inflection portion 41 formed at an end coil 40 of the coil spring is contactedly supported to the inner coil adjacent to the end coil 40, thereby cutting off the rotation moment from being transmitted to the support surface 42 of the end coil 40. Accordingly, only intervals between coils positioned between contact points of the inner coils, which are respectively in contact with the two inflection portions 41, are narrowed.

When the force applied from the outside is removed, coils intervals of which have been narrowed by its elasticity, return to initial positions to emit the absorbed force to the outside.

By repeating such processes, the coil spring absorbs an impact and a vibration transmitted from the outside to prevent them from being transmitted to other components. In addition, rotation of the coil spring, that is, a relative motion between the support surface 42 of the coil spring and other component is minimized thereby preventing friction and friction noise.

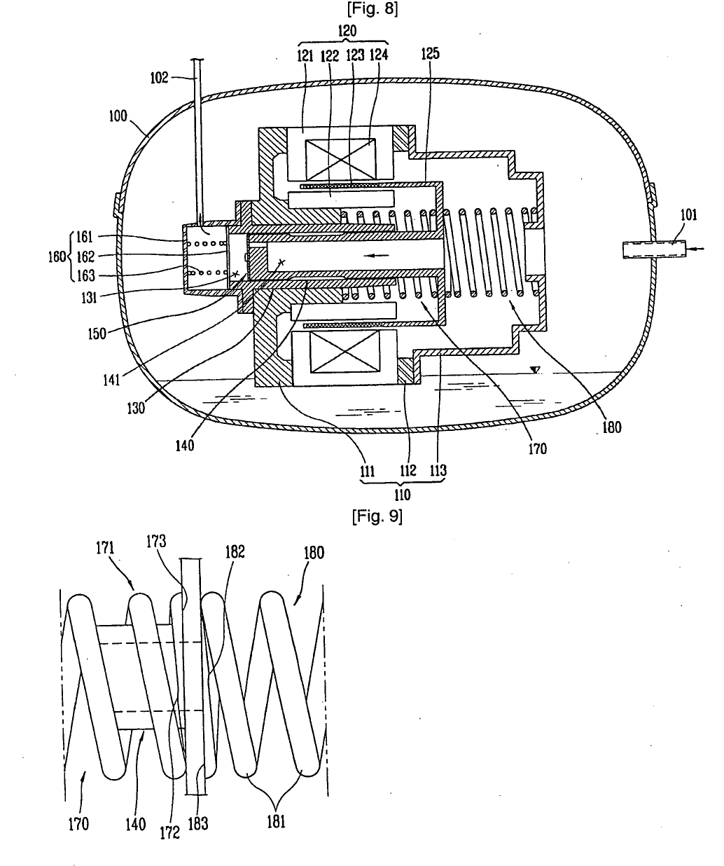

FIG. 8 is a sectional view showing one embodiment of the present invention of a reciprocating compressor with a coil spring in accordance with the present invention.

As shown therein, the reciprocating compressor includes: a casing 100 having a prescribed inner space therein; a frame unit 110 positioned in the casing 100; a driving motor 120 fixedly coupled to the frame unit 110, and generating a linearly reciprocating driving force; a cylinder 130 fixedly coupled to the frame unit 110; a piston 140 receiving the driving force of the driving motor 120, and reciprocally moved in an inner space 131 of the cylinder 130; a suction valve 150 for controlling gas introduced to the cylinder inner space 131; a discharge valve assembly 160 through which gas compressed in the cylinder 130 is discharged; and a resonant spring elastically supporting the piston 140 and causing a resonant movement of the piston 140.

The casing 100 has a prescribed inner space, and a suction pipe 101 and a discharge pipe 102 are respectively connected to the casing 100.

The frame unit 110 includes a front frame 111 formed in a prescribed shape; a middle frame 112 positioned at a certain interval from the front frame 111; and a rear frame 113 coupled to the middle frame 12.

The driving motor 120 includes an outer stator 121 fixedly coupled between the front frame 111 and the middle frame 112; an inner stator 122 inserted in the outer stator 121 and fixedly coupled to the front frame 111; and a magnet 123 movably positioned between the outer stator 121 and the inner stator 12. A winding coil is coupled inside the outer stator 121, and the magnet 123 is fixedly coupled to a magnet holder 125 having a cylindrical shape.

The cylinder 130 is coupled to the front frame 111.

The discharge valve assembly 160 includes a discharge cover 161 covering one side of the cylinder 130; a discharge valve 162 positioned inside the discharge cover 161, and opening/closing one side of the inner space 131 of the cylinder; and a discharge spring 163 positioned in the discharge cover 161 and elastically supporting the discharge valve 162. The discharge pipe 102 is connected to the discharge cover 161.

The piston 140 is inserted in the cylinder 130, and the magnet holder 125 is coupled to one side of the piston 140. A suction path 141 is formed in the piston 140, and a suction valve 150 for opening/closing the suction path 141 is mounted at an end portion of the piston 140.

The resonant spring includes a front coil spring 170 positioned between the front frame 111 and the magnet holder 125; and a rear coil spring 180 positioned between the rear frame 113 and the magnet holder 125. The front coil spring 170 and the rear coil spring 180 has the same structures, and the coil springs 170, 180 elastically support the piston 140.

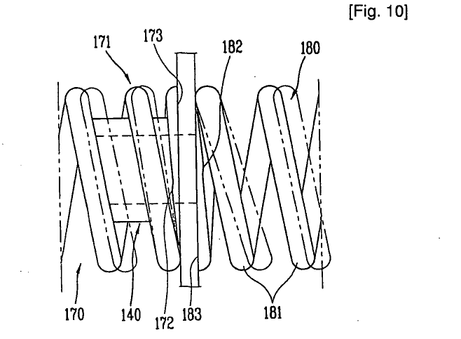

The front coil spring 170 and the rear coil spring 180 constituting the resonant spring has the same structure as the above mentioned coil spring. As shown in FIG. 9, the front and rear coil springs 170, 180 include coils 171, 181 formed as a wire having stiffness is wound plural times; and inflection portions 172, 182 having a nonlinear shape and each formed at outer circumferential surfaces of the coils positioned at both ends. The wire has a certain diameter, and is spirally wound. The outer surfaces of coils respectively positioned at both ends are planes perpendicular to an axis of the coil, and the planes are support surfaces 173, 183 which are in contact with other components.

More detailed descriptions thereon are the same as described above.

Both support surfaces 173 of the front coil spring 170 are contactedly supported to one side surface of the front frame 111 and an inner surface of the magnet holder 125, respectively. Both support surfaces 183 of the rear coil spring 180 are contactedly supported to an inner surface of the rear fame 113 and an outer surface of the magnet holder 125, respectively.

Hereinafter, operations of a reciprocating compressor with a coil spring in accordance with the present invention will now be described.

When power is applied to the reciprocating compressor, the driving motor 120 generates a linearly reciprocating driving force by an electromagnetic interaction, and the linearly reciprocating driving force is transmitted to the piston 140 through the magnet holder 125 to which a magnet 123 is coupled.

The piston 140 linearly reciprocates in the cylinder 130. As the piston 140 linearly reciprocates, a refrigerant is sucked into the cylinder inner space 131 and is compressed therein, and the compressed refrigerant is discharged outside the cylinder inner space 131. The discharged refrigerant is discharged outside the compressor through the discharge cover 161 and the discharge pipe 102.

The front coil spring 170 and the rear coil spring 180 are repeatedly constricted and relaxed, whereby a movement of the piston 140 resonates.

As shown in FIG. 10, in the process that the front coil spring 170 and the rear coil spring 180 are repeatedly constricted and relaxed whereby a movement of the piston 140 resonates, the inflection portions 172, 182 respectively provided at the front coil spring 170 and the rear coil spring 180 minimize a relative motion of the support surfaces 173, 183 of the front and rear coil springs with contact surfaces which are in contact with the support surfaces 173, 183. That is, relative motions between support surfaces 173 of the front coil spring and one side surface of the front frame 111 and the inner surface of the magnet holder 125 which are respectively in contact with the support surfaces 173 are minimized, and also relative motions between support surfaces 183 of the rear coil spring and the inner surface of the rear frame 113 and the outer surface of the magnet holder 125 which are respectively in contact with the support surfaces 183, are minimized.

As above, by minimizing a relative motion between the front and rear coil springs 170, 180 and other components, abrasion due to friction is prevented and friction noise is also prevented. If friction noise is generated between the front and rear coil springs 170, 180 and other components, the friction noise is transmitted to the casing 100 through other components such as a discharge pipe 102 or the like to emit the noise outside the casing 100.

As so far described, when a coil spring in accordance with the present invention is connected to other components and is constricted and relaxed to absorb an impact or a vibration transmitted from the outside, the coil spring minimizes a relative motion of itself with other components to prevent abrasion due to friction with other components, so that life spans of the coil spring and other components are prolonged, damage of other components including the coil spring are prevented, and friction loss is also prevented.

In a reciprocating compressor having the coil spring, abrasion due to friction between coil springs causing a resonant movement of a piston and other components (front frame, magnet holder, rear frame) contactedly supported to the coil spring, is prevented thereby prolonging life spans of the coil springs and other components and preventing damage thereof and noise generation by friction. Accordingly reliability of the compressor can be improved.

It will be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A coil spring comprising:
inner coils formed as a wire is wound plural times;
end coils positioned at both ends of the inner coils; and
an inflection portion having a nonlinear shape and formed at an outer circumferential surface of the end coil, which is positioned toward the inner coils.

2. The coil spring of claim 1, wherein the inflection portion is formed at an outer circumferential surface of the end coil in a protruded shape having a curved form

3. The coil spring of claim 1, wherein one or more inflection portion is provided.

4. The coil spring of claim 1, wherein an angle between the end coil and an inner coil adjacent to the end coil increases from an end of the end coil, having a fixed range of increase.

5. The coil spring of claim 1, wherein intervals between inner coils are regular.

6. The coil spring of claim 1, wherein pitch angles between inner coils are the same.

7. The coil spring of claim 1, wherein intervals between the inner coils are irregular.

8. The coil spring of claim 1, wherein an outer surface of the end coil is a plane perpendicular to an axis of the end coil.

9. The coil spring of claim 1, wherein outer diameters of the inner coils are the same.

10. The coil spring of claim 1, wherein distances from the ends of the end coils to the inflection portions respectively formed at the end coils are the same.

11. A coil spring formed as a coil is wound plural times comprising a protrusion having a prescribed height and formed protruded from an outer circumferential surface of the very outer coil, which faces a neighboring coil.

12. A reciprocating compressor comprising:
a casing;
a frame unit positioned in the casing;
a driving motor fixedly coupled to the frame unit and generating a linearly reciprocating driving motor;
a cylinder fixed to the frame unit;
a piston receiving the driving force of the driving motor and linearly reciprocating in the cylinder;
a suction valve for controlling gas introduced into the cylinder;
a discharge valve assembly through which gas compressed in the cylinder is discharged; and
coil springs elastically supporting the piston and causing a resonant movement of the piston,
wherein the coil spring comprises inner coils formed as a wire is wound plural times; end coils each formed at both ends of the inner coils; and an inflection portion having a nonlinear shape and formed at an outer circumferential surface of the end coil, which is positioned toward the inner coil.

13. The compressor of claim 12, wherein the inflection portion is formed at the side of a coil positioned at each end of coils, which faces the adjacent coil.

14. The compressor of claim 12, wherein the inflection portion is formed in a protruded shape having a curved form.
